(19) United States
(12) Patent Application Publication
(10) Pub. No.: US 2017/0099555 A1
(43) Pub. Date: Apr. 6, 2017

(54) Enabling Voice Interaction Using Secondary Microphone

(71) Applicant: Motorola Mobility LLC, Chicago, IL (US)

(72) Inventors: Rahul R. Singhvi, Palatine, IL (US); Subasri Iyyappan, Palatine, IL (US); Jagatkumar Shah, Lake in the Hills, IL (US)

(21) Appl. No.: 14/872,306

(22) Filed: Oct. 1, 2015

(51) Int. Cl. H04R 29/00; H04R 3/00; G10L 15/22

(52) U.S. Cl. CPC H04R 29/004; G10L 15/22; G10L 15/222; H04R 3/00; G10L 2015/223; H04R 2499/11

(57) ABSTRACT

A method includes identifying an active state of a first microphone of a device. A signal generated by a second microphone of the device is monitored to identify a voice command trigger phrase. The signal from the second microphone is monitored for a voice command responsive to identifying the voice command trigger phrase. The voice command is executed.

### BACKGROUND

Field of the Disclosure

The disclosed subject matter relates generally to mobile computing systems and, more particularly, to enabling voice interaction using a secondary microphone.

Description of the Related Art

Many mobile devices allow user interaction through natural language voice commands. Typically, a user presses a button or speaks a “trigger” phrase to enable the voice communication. Often, the user desires to employ voice commands to operate in a hands-free mode, such as while driving. However, during periods of microphone usage, such as during a call (e.g., telephone call, conferencing session, etc.), voice commands are suppressed. As a result, to perform functions, such as adding another party to the call, a user must physically interact with the device using manual inputs to register the commands, thereby preventing a true hands-free environment.

The present disclosure is directed to various methods and devices that may solve or at least reduce some of the problems identified above.

### BRIEF DESCRIPTION OF THE DRAWINGS

The present disclosure may be better understood, and its numerous features and advantages made apparent to those skilled in the art by referencing the accompanying drawings.

FIG. 1 is a simplified block diagram of a communication system for enabling voice interaction with a mobile device, according to some embodiments disclosed herein; and

FIG. 2 is a flow diagram of a method for enabling voice interaction with a mobile device, according to some embodiments disclosed herein.

The use of the same reference symbols in different drawings indicates similar or identical items.

### DETAILED DESCRIPTION OF EMBODIMENT(S)

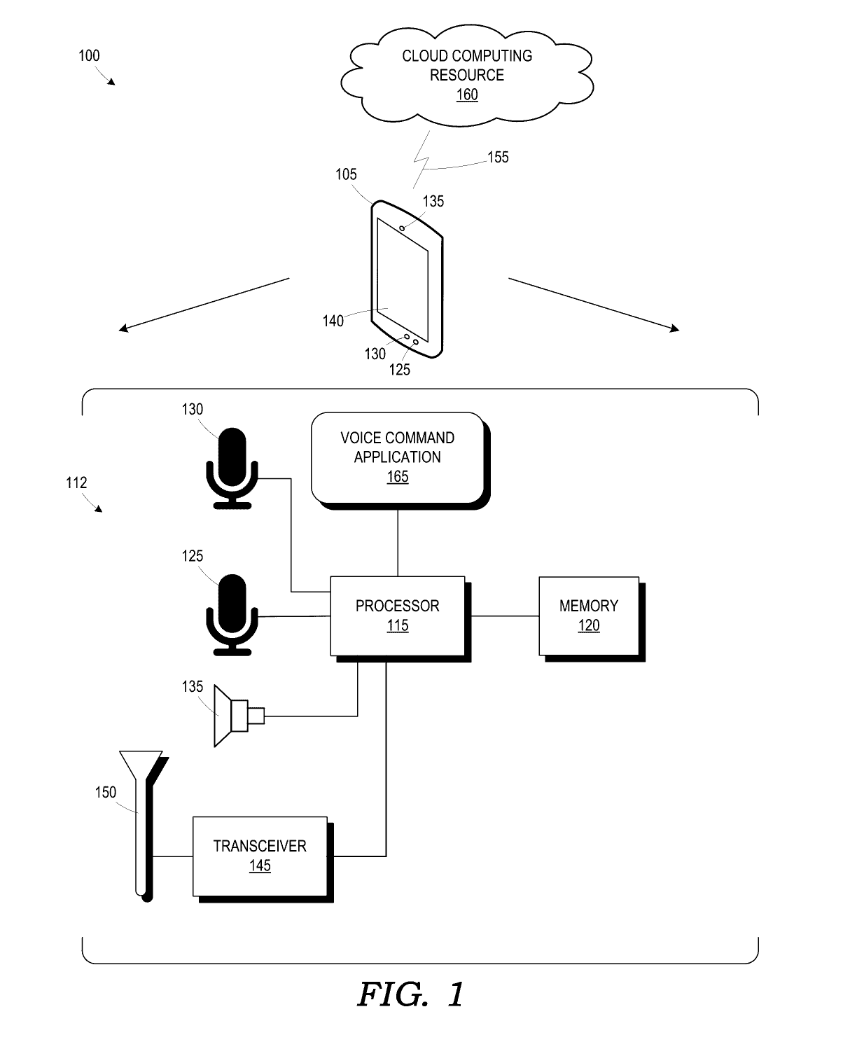

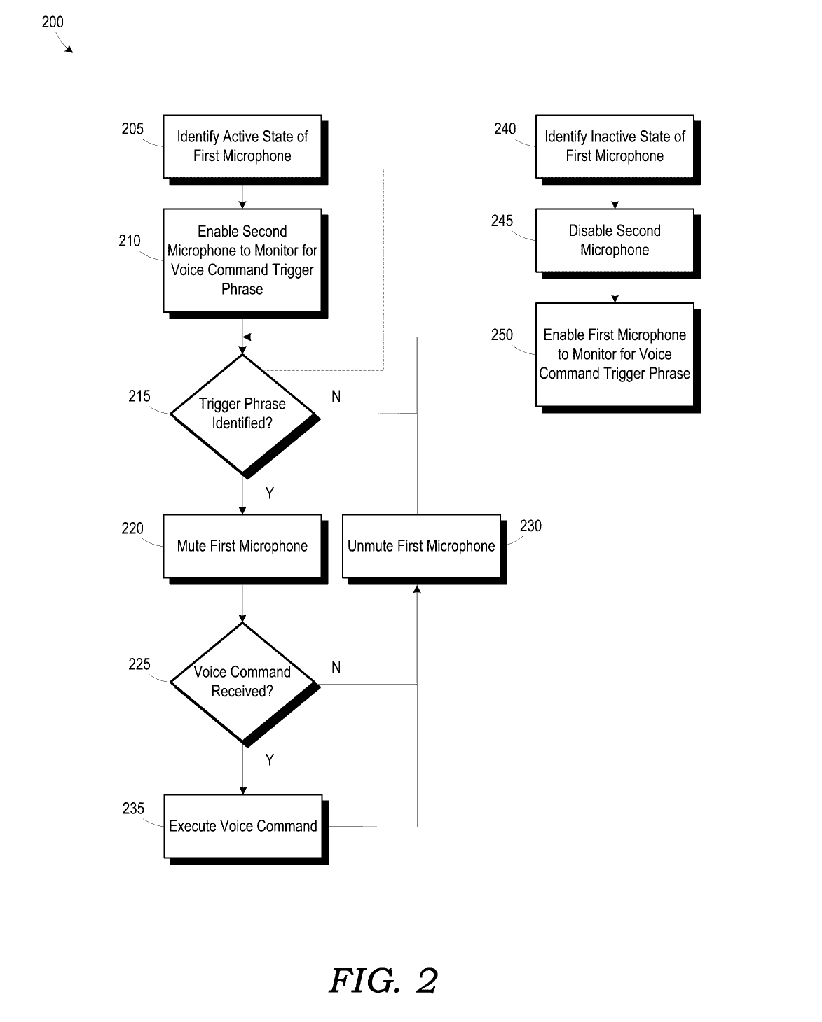

FIGS. 1-2 illustrate example techniques for enabling voice interaction with a mobile device during periods of primary microphone usage using a secondary microphone. While a primary microphone of the device is engaged to service a different application, such as a call or conferencing session, a secondary microphone is employed to monitor the user's speech to identify a voice command trigger phrase. After registering the trigger phrase, the device listens for and executes a subsequent voice command from the user. Because the triggering or initiation of the voice mode of operation is event driven rather than user driven, it is more natural for the user and more efficient from a power consumption standpoint.

FIG. 1 is a simplistic block diagram of a communications system 100 including a device 105. The device 105 implements a computing system 112 including, among other things, a processor 115, a memory 120, a first microphone 125, a second microphone 130, a speaker 135, and a display 140. The memory 120 may be a volatile memory (e.g., DRAM, SRAM) or a non-volatile memory (e.g., ROM, flash memory, hard disk, etc.). The device 105 includes a transceiver 145 for transmitting and receiving signals via an antenna 150 over a communication link 155. The transceiver 145 may include one or more radios for communicating according to different radio access technologies, such as cellular, Wi-Fi, Bluetooth®, etc. The communication link 155 may have a variety of forms. In some embodiments, the communication link 155 may be a wireless radio or cellular radio link. The communication link 155 may also communicate over a packet-based communication network, such as the Internet. In one embodiment, a cloud computing resource 160 may interface with the device 105 to implement one or more of the functions described herein.

In various embodiments, the device 105 may be embodied in a handheld or wearable device, such as a laptop computer, a handheld computer, a tablet computer, a mobile device, a telephones, a personal data assistants, a music player, a game device, a wearable computing device, and the like. To the extent certain example aspects of the device 105 are not described herein, such example aspects may or may not be included in various embodiments without limiting the spirit and scope of the embodiments of the present application as would be understood by one of skill in the art.

In the device 105, the processor 115 may execute instructions stored in the memory 120 and store information in the memory 120, such as the results of the executed instructions. Some embodiments of the processor 115, the memory 120, and the microphones 125, 130 may be configured to implement a voice command application 165 and perform portions of a method 200 shown in FIG. 2 and discussed below. For example, the processor 115 may execute the voice command application 165 to identify voice commands using the second microphone 130 while the first microphone is actively used by a different application, such as when the user is engaged in a call or conferencing session. One or more aspects of the method 200 may also be implemented using the cloud computing resource 160 in addition to the voice command application 165.

FIG. 2 is a flow diagram of an illustrative method 200 for enabling voice interaction with a device, in accordance with some embodiments disclosed herein. In one example, various elements of the method 200 shown in FIG. 2 may be implemented on the device 105. In some embodiments, the cloud computing resource 160 (see FIG. 1) may also be used to perform one or more elements of the method 200.

In method block 205, an active state of the first microphone 125 is identified by the voice command application 165. In some embodiments, the active state may be associated with an ongoing telephone call, video call, conferencing session, etc.

In method block 210, the voice command application 165 enables the second microphone 130 to monitor for a voice command trigger phrase. Although not illustrated in FIG. 2, prior to identifying the active sate of the first microphone 125 in method block 205, the voice command application 165 may have been monitoring the first microphone 125 to identify a voice command trigger phrase.

In method block 215, the voice command application 165 monitors the second microphone 130 to identify a voice command trigger phrase. If a trigger phrase is identified in method block 215, the voice command application 165, mutes the first microphone in method block 220 and monitors the second microphone for a voice command in method block 225. Muting the first microphone 125 prevents other parties from hearing the voice command thereby avoiding a disruption to the voice communication. The monitoring in method block 225 may be associated with a predetermined time window. If no voice command is identified within the time window, the voice command application 165 unmutes the first microphone in method block 230 and returns to method block 215.

If a voice command is identified in method block 225, the voice command is executed in method block 235. The device 105 responds to the user according to the command. In some embodiments, the voice command may include a command to add another party to the call or conference, to perform an internet search, to send a message to another party, etc. The executing of the voice command may also including voicing a response message to the user using the speaker 135 to communicate the results of the processing performed, such as when the voice command is a query for information.

After executing the voice command in method block 235, the voice command application 165 transitions to method block 230 to unmute the first microphone 125 and then tm method block 215 to monitor for another voice command trigger phrase.

In method block 240, the voice command application 165 detects that the first microphone 125 is not active (i.e., based on the termination of the call). For example, the first microphone 125 may become inactive during the monitoring of method block 215. The voice command application 165 exits from method block 215 as indicated by the dashed line. The voice command application 165 disables the second microphone 130 in method block 245 and enables the first microphone 125 to monitor for a voice command trigger phrase in method block 250.

Enabling voice interaction with the device 105 using the second microphone 130 while the first microphone 125 is already active improves the user experience and increases the depth of the hands-free environment.

In some embodiments, certain aspects of the techniques described above may implemented by one or more processors of a processing system executing software. The method 200 described herein may be implemented by executing software on a computing device, such as the processor 115 of FIG. 1, however, such methods are not abstract in that they improve the operation of the device 105 and the user's experience when operating the device 105. Prior to execution, the software instructions may be transferred from a non-transitory computer readable storage medium to a memory, such as the memory 120 of FIG. 1.

The software may include one or more sets of executable instructions stored or otherwise tangibly embodied on a non-transitory computer readable storage medium. The software can include the instructions and certain data that, when executed by one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

A method includes identifying an active state of a first microphone of a device. A signal generated by a second microphone of the device is monitored to identify a voice command trigger phrase. The signal from the second microphone is monitored for a voice command responsive to identifying the voice command trigger phrase. The voice command is executed.

A device includes a first microphone, a second microphone, and a processor coupled to the first and second microphones. The processor is to identifying an active state of the first microphone, monitor a signal generated by the second microphone to identify a voice command trigger phrase, monitor the signal from the second microphone for a voice command responsive to identifying the voice command trigger phrase, and execute the voice command.

A method includes identifying an active state of a first microphone of a device. A signal generated by a second microphone of the device is monitored to identify a voice command trigger phrase. The first microphone is muted and the signal from the second microphone is monitored for a voice command responsive to identifying the voice command trigger phrase. The voice command is executed. The first microphone is unmuted after executing the voice command.

The particular embodiments disclosed above are illustrative only, as the invention may be modified and practiced in different but equivalent manners apparent to those skilled in the art having the benefit of the teachings herein. For example, the process steps set forth above may be performed in a different order. Furthermore, no limitations are intended to the details of construction or design herein shown, other than as described in the claims below. It is therefore evident that the particular embodiments disclosed above may be altered or modified and all such variations are considered within the scope and spirit of the invention. Note that the use of terms, such as “first,” “second,” “third” or “fourth” to describe various processes or structures in this specification and in the attached claims is only used as a shorthand reference to such steps/structures and does not necessarily imply that such steps/structures are performed/formed in that ordered sequence. Of course, depending upon the exact claim language, an ordered sequence of such processes may or may not be required. Accordingly, the protection sought herein is as set forth in the claims below.

What is claimed is:

1. A method comprising:
identifying an active state of a first microphone of a device;
monitoring a signal generated by a second microphone of the device to identify a voice command trigger phrase;
monitoring the signal from the second microphone for a voice command responsive to identifying the voice command trigger phrase; and
executing the voice command.

2. The method of claim 1, further comprising muting the first microphone while monitoring the signal from the second microphone for the voice command.

3. The method of claim 1, further comprising muting the first microphone while executing the voice command.

4. The method of claim 1, wherein monitoring the signal from the second microphone for the voice command comprises monitoring the signal from the second microphone for the voice command for a predetermined time interval.

5. The method of claim 1, further comprising:
identifying an inactive state of the first microphone; and
monitoring a signal generated by the first microphone to identify a subsequent voice command trigger phrase.

6. The method of claim 1, wherein identifying the active state of the first microphone comprises identifying that the device is engaged in a call.

7. The method of claim 1, wherein executing the voice command further comprises generating a response to the voice command on a speaker of the device.

8. The method of claim 7, further comprising muting the first microphone while generating the response on the speaker.

9. A device, comprising:
a first microphone;
a second microphone; and
a processor coupled to the first and second microphones, wherein the processor is to identifying an active state of the first microphone, monitor a signal generated by the second microphone to identify a voice command trigger phrase, monitor the signal from the second microphone for a voice command responsive to identifying the voice command trigger phrase, and execute the voice command.

10. The device of claim 9, wherein the processor is to mute the first microphone while monitoring the signal from the second microphone for the voice command.

11. The device of claim 9, wherein the processor is to mute the first microphone while executing the voice command.

12. The device of claim 9, wherein the processor is to monitor the signal from the second microphone for the voice command for a predetermined time interval.

13. The device of claim 9, wherein the processor is to identify an inactive state of the first microphone, and monitoring a signal generated by the first microphone to identify a subsequent voice command trigger phrase.

14. The device of claim 9, wherein the processor is to identify the active state of the first microphone by identifying that the device is engaged in a call.

15. The device of claim 9, wherein the processor is to generate a response to the voice command on a speaker of the device.

16. The device of claim 15, wherein the processor is to mute the first microphone while generating the response on the speaker.

17. A method comprising:
identifying an active state of a first microphone of a device;
monitoring a signal generated by a second microphone of the device to identify a voice command trigger phrase;
muting the first microphone and monitoring the signal from the second microphone for a voice command responsive to identifying the voice command trigger phrase;
executing the voice command; and
unmuting the first microphone after executing the voice command.

18. The method of claim 17, wherein monitoring the signal from the second microphone for the voice command comprises monitoring the signal from the second microphone for the voice command for a predetermined time interval.

19. The method of claim 17, further comprising:
identifying an inactive state of the first microphone; and
monitoring a signal generated by the first microphone to identify a subsequent voice command trigger phrase.

20. The method of claim 17, wherein executing the voice command further comprises generating a response to the voice command on a speaker of the device.
